(19) United States
(12) Patent Application Publication
(10) Pub. No.: US 2008/0277858 A1
(43) Pub. Date: Nov. 13, 2008

(54) Folding machine and printing machine using same

(75) Inventors: Kunihiro Shichijo, Mihara (JP); Mikio Motooka, Mihara (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD, Tokyo (JP)

(21) Appl. No.: 12/073,290

(22) Filed: Mar. 4, 2008

(30) Foreign Application Priority Data
May 7, 2007 (JP) 2007-122350

(51) Int. Cl. B41F 13/64; B42C 1/00

(52) U.S. Cl. 270/12; 270/45

(57) ABSTRACT

A folding machine includes a lower conveyance belt that forms a lower conveyance path section for guiding and conveying a signature by a lower conveyance surface, an upper conveyance belt that forms an upper conveyance path section for guiding and conveying the signature by an upper conveyance surface, a chopper table for guiding the lower conveyance belt, a stopper for aligning a downstream end position of the signature, and a chopper blade for forming a chopper signature. A coefficient of static friction of the lower conveyance surface and the upper conveyance surface to an iron surface is 0.2 or more and less than 0.3, and a nip roller for increasing holding force to the signature between the lower conveyance surface and the upper conveyance surface is provided at a part more upstream side than the stopper by at least a length of the signature.

### BACKGROUND OF THE INVENTION

1. Field of the Invention

The present invention relates to a folding machine and to a printing machine that uses the folding machine.

This application is based on Japanese Patent Application No. 2007-122350, the content of which is incorporated herein by reference.

2. Description of Related Art

Conventionally, in a folding machine in a printing machine, a signature is cut and folded in a sheet-shape in an upstream process, and conveyed by a vertically arranged pair of conveyance belts. During the conveyance, if necessary, the signature is folded in two along a conveyance direction by a chopper folding machine.

The signature being conveyed by the conveyance belts comes in contact with a stopper, a tip of the signature is aligned, and pressed downward by a chopper blade that is lowered from above. Thus, the signature is folded in two while being pressed downward, and discharged to a paper discharge conveyer through an impeller that is provided at a lower part.

Since it is necessary to accurately convey the signature at an accurate timing, conveyance surfaces of the vertically arranged pair of conveyance belts are formed to have a high coefficient of friction to sufficiently hold the signature.

The conveyance surfaces are formed of a material that has a high coefficient of friction, for example, rubber, and the friction coefficient to a surface of an iron material is set to 0.3 or more. On the other hand, the signature is conveyed at a high speed substantially same as the printing speed.

Accordingly, the tip of the signature collides with the stopper, and further, strong force acts on the signature in the conveyance direction. Then, the strong force acts on the tip of the signature, and a misshapen fold or a rip of the signature may be formed.

Further, generally, a plurality of pairs of conveyance belts is provided, and the conveyance belts are symmetrically arranged with a center, that is, the folding position by the chopper blade respectively. When the signature is folded by the chopper blade, as the folding proceeds, both ends of the signature are moved toward the center. However, the signature holding force by the conveyance belts is large, and signature may not be smoothly moved. Accordingly, the force of the stopper may act on the both ends of the tip of the signature for a longer time, and therefore misshapen folds or rips of the signature may be formed, especially at the both ends.

Further, if the signature holding force by the conveyance belts is slightly imbalanced, the movement amounts of the signature at the both ends vary. Then, the signature may not be accurately folded in two, and the accuracy of the folding may be decreased.

Due to the above-described problems, the quality of the signature may be significantly reduced, and troubles may occur in folding in downstream folding or alignment processes.

To solve the problems, in conventional arts, the timing to lower the chopper blade is adjusted. However, the adjustment is difficult, and sufficient results have not been obtained.

Accordingly, various technologies have been proposed to solve the problems.

For example, in Japanese Unexamined Patent Application Publication No. 11-236167 (hereinafter, referred to as “document 1”), and Japanese Unexamined Patent Application Publication No. 11-180635 (hereinafter, referred to as “document 2”), devices that reduce speeds of signatures in colliding with stoppers to reduce the impact of the collision with the stoppers have been proposed.

The device discussed in document 1 includes a plurality of pairs of conveyance belts in a conveyance direction and gradually reduces the speed of the signature.

The device discussed in document 2 includes a pair of vertically arranged speed reduction conveyance belts that travel at a low speed at a part of a chopper folding machine in addition to a pair of vertically arranged main conveyance belts. Using the speed-reduction conveyance belts, the conveyance speed of the signature is reduced.

Further, Japanese Unexamined Patent Application Publication No. 11-116135 (hereinafter, referred to as “document 3”) has proposed a device that includes means for adjusting a space between a pair of vertically arranged conveyance belts at a part of a chopper folding machine. Using the means, force for holding a signature at the part is weakened at the part, and the impact of the collision with a stopper is reduced.

However, the device discussed in document 1 is complicated in the structure, and the folding machine is large. Further, it is substantially difficult to adjust the speeds of each conveyance belt to appropriate speeds corresponding to change in paper quality, paper thickness, the number of pages, and the like.

Also, the device discussed in document 2 is complicated in the structure of the chopper folding machine, and it is substantially difficult to adjust the speeds of the speed-reduction conveyance belt to appropriate speeds corresponding to change in paper quality, paper thickness, the number of pages, and the like.

The device discussed in document 3 cannot convey the signature accurately if the space between the pair of vertically arranged conveyance belts is too wide. On the contrary, if the space between the pair of vertically arranged conveyance belts is too narrow, it is substantially difficult that the device adjusts the space corresponding to the change in paper quality, paper thickness, the number of pages, and the like.

### BRIEF SUMMARY OF THE INVENTION

The present invention has been made in view of the above, and an object of the present invention is to provide a folding machine that has a simple structure and does not substantially require adjustment, and improves the folding accuracy to obtain good products, and to provide a printing machine that uses the folding machine.

To solve the above-described problems, the following solutions are employed.

That is, according to a first aspect of the present invention, a folding machine includes an endless lower conveyance belt that forms a lower conveyance path section for guiding and conveying a lower surface of a signature by a lower conveyance surface of an outer circumference side, an endless upper conveyance belt that forms an upper conveyance path section for guiding and conveying an upper surface of the signature by an upper conveyance surface of an outer circumference side, a chopper table that is installed below the lower conveyance path section, and guides an inner circumference surface of an inner circumference side of the lower conveyance belt, a stopper that is installed on the chopper table and aligns a downstream end position of the signature, and a chopper blade for folding the signature in two along a signature conveyance direction. A coefficient of static friction of the lower conveyance surface and the upper conveyance surface to a surface formed of an iron material is 0.2 or more and less than 0.3, and a holding force increasing section for increasing holding force to the signature between the lower conveyance surface and the upper conveyance surface is provided at a part more upstream side than the stopper in the lower conveyance path section and the upper conveyance path section by at least a length of the signature.

According to the first aspect of the present invention, the coefficient of static friction of the lower conveyance surface and the upper conveyance surface to the surface formed of the iron material is set to 0.2 or more and less than 0.3, which is smaller than conventional values. Accordingly, the conveyance force for conveying the signature by the lower conveyance belt and the upper conveyance belt, that is, the holding force for holding the signature against the external force, can be reduced.

Further, the holding force increasing section for increasing the holding force to the signature between the lower conveyance surface and the upper conveyance surface is provided at the part more upstream side than the stopper in the lower conveyance path section and the upper conveyance path section by at least the length of the signature. Accordingly, at the upstream side part, the holding force acting on the lower conveyance surface and the upper conveyance surface can be increased.

If the holding force acting on the signature is increased, it is possible to increase the conveyance force for conveying the signature on the lower conveyance surface and the upper conveyance surface. Accordingly, the reduction of the conveyance force with the reduction of the coefficient of static friction of the lower conveyance surface and the upper conveyance surface can be compensated, and the conveyance force can be maintained and ensured at a level higher than a necessary level.

As described above, according to the first aspect of the present invention, the signature is held by the lower conveyance belt and the upper conveyance belt and with the conveyance, at the upstream side part than the stopper by at least the length of the signature, the signature is conveyed with the sufficient conveyance force. Accordingly, the attitude of the signature can be maintained and the signature can be conveyed in good condition without displacement.

When the signature passes through the point that is away from the stopper by the length of the signature, the signature is conveyed while the area which is lightly held by the lower conveyance belt and the upper conveyance belt expands from the tip of the signature, as the ratio of the area is gradually increased. At the point where the tip of the signature comes in contact with the stopper, the entirety of the signature is lightly held by the lower conveyance belt and the upper conveyance belt. Accordingly, when the signature is in contact with the stopper, under the reaction force due to the contact, the signature can readily move. That is, the impact force generated when the signature is in contact with the stopper can be reduced. Accordingly, a misshapen fold or a rip of the signature due to the strong force acting on the tip of the signature can be prevented, and the position of the tip of the signature can be readily aligned.

Further, in folding the signature using the chopper blade, since the coefficient of static friction of the lower conveyance surface and the upper conveyance surface is small, the both ends of the signature can be smoothly moved toward the central part as the folding proceeds. Further, even if the holding forces of the signature by the lower conveyance belt and the upper conveyance belt in the width direction are imbalanced, variations of the movement amounts of the both ends can be reduced.

Accordingly, the chopper blade can accurately fold the signature in two, and inaccurate folding can be reduced. Further, adjustments corresponding to change in paper quality of the signature, thickness of the paper, the number of pages, and the like can be substantially eliminated.

Further, since the lower conveyance belt and the upper conveyance belt are merely substituted, and the holding force increasing section is merely added, the structure of the folding machine is simple as compared to cases that a plurality of pairs of the lower conveyance belts and the upper conveyance belts are provided or a set of the lower conveyance belt and the upper conveyance belt is added. Accordingly, the folding machine can be downsized and inexpensively manufactured.

In the folding machine according to the first aspect of the present invention, the holding force increasing section may be a convex section formed by protruding the lower conveyance path section and the upper conveyance path section upward or downward along the conveyance direction.

As described above, in the convex section, the lower conveyance path section and the upper conveyance path section are formed to protrude upward or downward along the conveyance direction. Accordingly, at least one bent section is included. The peripheral velocities of the inside and outside of the signature passing through the bent section differ from each other. Meanwhile, the lower conveyance belt and the upper conveyance belt, that is, the lower conveyance surface and the upper conveyance surface move at a substantially same speed. Thus, a speed difference occurs between the lower conveyance surface and the upper conveyance surface and the surface of the signature. Then, a force to even the speed difference, that is, a movement to press the signature is generated. Accordingly, the holding force for holding the signature by the lower conveyance surface and the upper conveyance surface is increased.

During the conveyance, a slip may occur between the lower conveyance surface and the upper conveyance surface and the surface of the signature. However, the coefficient of static friction of the lower conveyance surface and the upper conveyance surface is set to a small value. Accordingly, the signature can be smoothly slipped, and the signature can be prevented from being damaged.

As described above, by forming the convex section in the lower conveyance path section and the upper conveyance path section, the holding force increasing section can be formed. Then, the structure of the holding force increasing section can be simplified.

To always obtain the increased holding force for the signature passing through the convex section, it is preferred to provide a plurality of the bent sections or to form the bent section long enough so that the signature can be caught by the bent section, no matter where the signature passes.

In the first aspect of the present invention, preferably, the convex section is formed according to a curvature of a plate-like member for guiding the lower conveyance belt or the upper conveyance belt.

With the structure, the bent section that the curvature of the plate-like member increases the holding force can be formed. Accordingly, the area for increasing the holding force can be formed long in the conveyance direction.

The curvature of the plate-like member may be set to smoothly bend the member, or to form a polygonal shape having smooth corners. That is, the idea of bending includes the polygonal shape. In forming the polygonal shape, preferably, spaces of the corners in the conveyance direction are set at least shorter than the length of the signature.

With the structure, the signature passing through the corner sections can be surely caught by any one of the corner sections, no matter where the signature passes. Accordingly, the signature can be conveyed in the state that the holding force is always increased.

In the first aspect of the present invention, preferably, the convex section is formed by a plurality of roller members for guiding the lower conveyance belt or the upper conveyance belt.

In the structure, the section guided by the roller members forms a bent section for increasing the holding force. Accordingly, the section for increasing the holding force can be separately formed at a plurality of points in the conveyance direction.

In the above case, preferably, spaces between the roller members in the conveyance direction are shorter than the length of the signature.

In the structure, the signature that passes through the convex section is surely caught by any one of the roller members, no matter where the signature passes. Accordingly, the signature can be conveyed in the state that the holding force is always increased.

In the first aspect of the present invention, preferably, the chopper table includes a horizontal section that is equal to or longer than at least the length of the signature and substantially horizontal at a part more upstream side than the stopper.

In the structure, when the tip of the signature comes in contact with the stopper, the signature is held by the horizontal section that is substantially horizontal of the chopper table. Accordingly, the signature is folded by the chopper blade in a substantially horizontal state, and the folding accuracy can be increased.

In the first aspect of the present invention, preferably, the coefficient of static friction of the inner circumference surfaces of the inner circumference side of the lower conveyance belt and the upper conveyance belt to the surface formed of the iron material is 0.3 or more and less than 0.5.

In the structure, the inner circumference surfaces of the lower conveyance belt and the upper conveyance belt, and a drive member (drive pulley or drive roller) are hard to slip. Then, drive force of the drive member is transmitted to the lower conveyance belt and the upper conveyance belt. Accordingly, the lower conveyance belt and the upper conveyance belt are driven with the sufficient drive force.

A printing machine according to a second aspect of the present invention includes any one of the folding machine according to the first aspect of the present invention.

The printing machine according to the second aspect of the present invention includes the folding machine that is simple in structure, small, inexpensively manufacturable, substantially does not require adjustment corresponding to change of the signature, and is improved in folding accuracy to obtain good products. Accordingly, the printing machine can be downsized and produce good products.

According to the aspects of the present invention, the coefficient of static friction of the lower conveyance surface and the upper conveyance surface to the surface formed of the iron material is set to 0.2 or more and less than 0.3. Further, the holding force increasing section for increasing the holding force to the signature between the lower conveyance surface and the upper conveyance surface is provided at the part more upstream side than the stopper in the lower conveyance path section and the upper conveyance path section by at least the length of the signature. Accordingly, at the upstream side part than the stopper by at least the length of the signature, the attitude of the signature can be maintained with the sufficient conveyance force, and the signature can be conveyed in good condition without displacement.

Further, at the point where the tip of the signature is in contact with the stopper, the entirety of the signature is lightly held by the lower conveyance belt and the upper conveyance belt. Accordingly, a misshapen fold or a rip of the signature can be prevented from being formed due to the strong force acting on the tip of the signature in contact with the stopper, and the position of the tip of the signature can be readily aligned. Thus, good products improved in the folding accuracy can be obtained.

Further, since the lower conveyance belt and the upper conveyance belt are merely substituted, and the holding force increasing section is merely added, the structure of the folding machine is simple as compared to cases that a plurality of pairs of the lower conveyance belts and the upper conveyance belts are provided or a set of the lower conveyance belt and the upper conveyance belt is added. Accordingly, the folding machine can be downsized and inexpensively manufactured.

### BRIEF DESCRIPTION OF THE SEVERAL VIEWS OF THE DRAWINGS

FIG. 1 is a front elevation view illustrating a schematic structure of an entire web press according to a first embodiment of the present invention.

FIG. 2 is a view illustrating a schematic structure of a conveyance belt section and a chopper folding machine section according to the first embodiment of the present invention.

FIG. 3 is a cross sectional view taken along the line X-X of FIG. 2.

FIG. 4 is a cross sectional view illustrating a lower conveyance belt according to the first embodiment of the present invention.

FIG. 5 is a perspective view illustrating a signature formed using a holding cylinder.

FIG. 6 is a perspective view illustrating a chopper signature.

FIG. 7 is a cross sectional view illustrating a conventional lower conveyance belt.

FIG. 8 is a view illustrating a schematic structure of a conveyance belt section and a chopper folding machine section according to a second embodiment of the present invention.

FIG. 9 is a view illustrating another convex section according to the second embodiment of the present invention.

### DETAILED DESCRIPTION OF THE INVENTION

Hereinafter, embodiments of the present invention will be described with reference to the drawings.

### First Embodiment

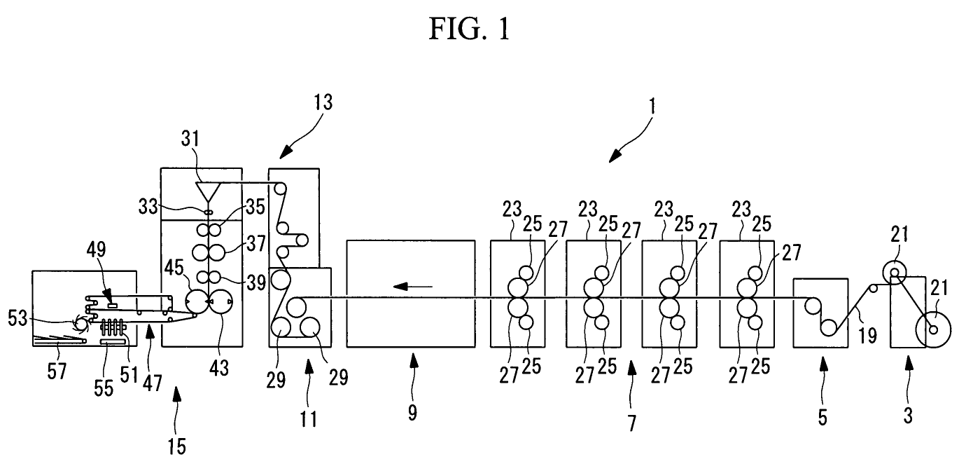

A first embodiment of the present invention is described with reference to FIGS. 1 to 6.

In the first embodiment, the present invention is applied to an opposed blanket type web press that perform multicolor printing on both sides of a web.

FIG. 1 is a front elevation view illustrating a schematic structure of an entire web press (printing machine) 1.

The web press 1 includes, along a conveyance direction of a web 19, a paper feed device 3, an in-feed device 5, a printing section 7, a drying device 9, a cooling device 11, a web pass section 13, and a folding machine 15.

The paper feed device 3 supplies a web 19, and holds two paper rolls 21 that are formed of rolled webs 19.

While the paper is supplied from one paper roll 21, the other paper roll 21 is installed to prepare for paper splicing. When the web 19 of the one paper roll 21 comes to an end, the web 19 is spliced to the web 19 of the other paper roll 21. While the web 19 is supplied from the other paper roll 21, the one paper roll 21 is installed to prepare for paper splicing.

Thus, the web 19 is continuously supplied from the paper feed device 3 to the downstream side in the conveyance direction.

The in-feed device 5 has a function to adjust tension of the web 19 from the paper feed device 3 and supply the web 19 to the printing section 7.

The printing section 7 includes printing units 23. The number of the printing units 23 corresponds to the number of print colors.

In the first embodiment, four printing units 23 are provided, and the printing units 23 print cyan, yellow, magenta, and black respectively. Using mixed colors of these colors, color printing is performed.

The print units 23 include two pairs of plate cylinders 25 and blanket cylinders 27 respectively. The blanket cylinders 27 of each pair are disposed to be opposed to each other across the web 19, and apply printing pressure to each other.

On peripheries of each plate cylinder 25, dampening arrangements and inking devices (not shown) are provided respectively. The dampening devices supply dampening water on plates attached on the peripheries of the plate cylinders 25. The inking devices supply ink on the plates.

The drying device 9 heats and dries the web 19 that is printed by the printing section 7 on both sides.

The cooling device 11 includes a plurality of cooling drums 29. The cooling device 11 cools the web 19 that is heated by the drying device 9 by being passed the web 19 through each cooing drum 29 so that the web 19 comes in contact with the peripheries of each cooling drum 29.

The web pass section 13 adjusts the tension of the web 19, folds the web 19 in two by a trigon 31 along the conveyance direction, and supplies the web 19 to the folding machine 15. If necessary, the web pass section 13 longitudinally cuts the web 19.

The trigon 31 longitudinally folds the web 19, or do nothing for the web 19 that is narrow in width, and turns the traveling direction of the surface of the web 19 by 90 degrees.

A lead-in roller 33 includes a pair of rollers that is arranged with a space, and guides downward the longitudinally folded web 19 from the trigon 31.

The folding machine 15 includes a first nipping roller section 35, a second nipping roller section 39, a folding cylinder 43, a holding cylinder 45, a conveyance belt section 47, a chopper folding device 49, a right-angle folding impeller 51, a parallel folding impeller 53, and discharge conveyers 55 and 57.

The first nipping roller section 35 and the second nipping roller section 39 apply tension to the web 19 and feed the web 19 to the downstream side.

On the periphery of the folding cylinder 43, two pairs of folding blades are provided at intervals of about 180 degrees. Further, on the periphery of the folding cylinder 43, a needle device that conveys the web 19 and a cutting blade that cuts the web 19 are provided.

On the periphery of the holding cylinder 45, two pairs of holding members are provided at intervals of about 180 degrees. The holding members are set to correspond to the folding blades of the folding cylinder 43.

The first nipping roller section 35 and the second nipping roller section 39 apply tension to the web 19 and feed the web 19 to the downstream side.

A lateral sewing machine 37 perforates the web 19 along the width direction to facilitate folding in a downstream step.

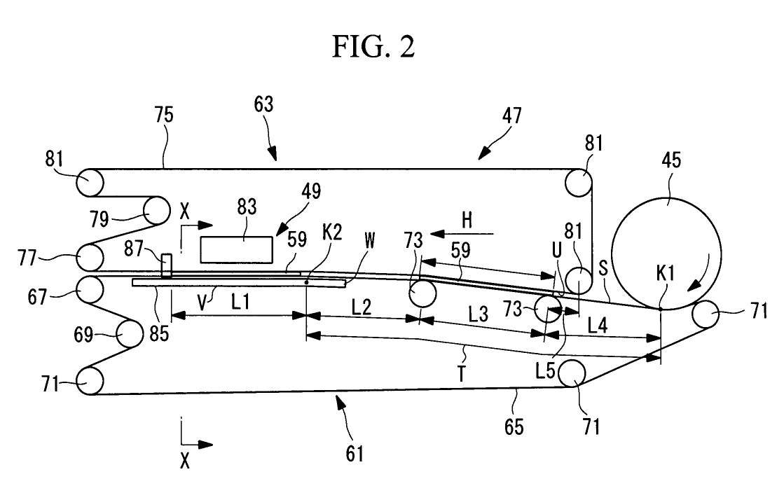

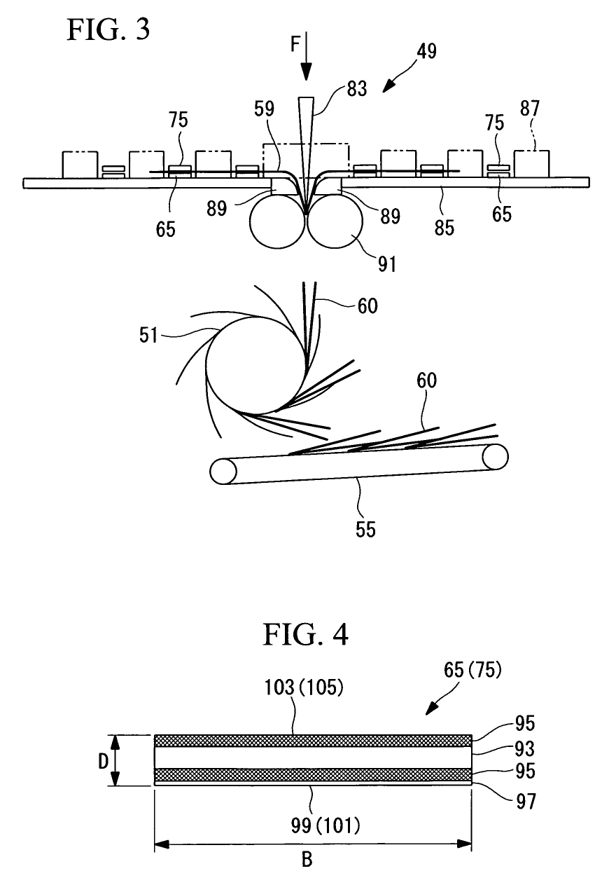

FIG. 2 is a front elevation view illustrating the conveyance belt section 47 and the chopper folding device 49. FIG. 3 is a cross sectional view taken along the line X-X of FIG. 2.

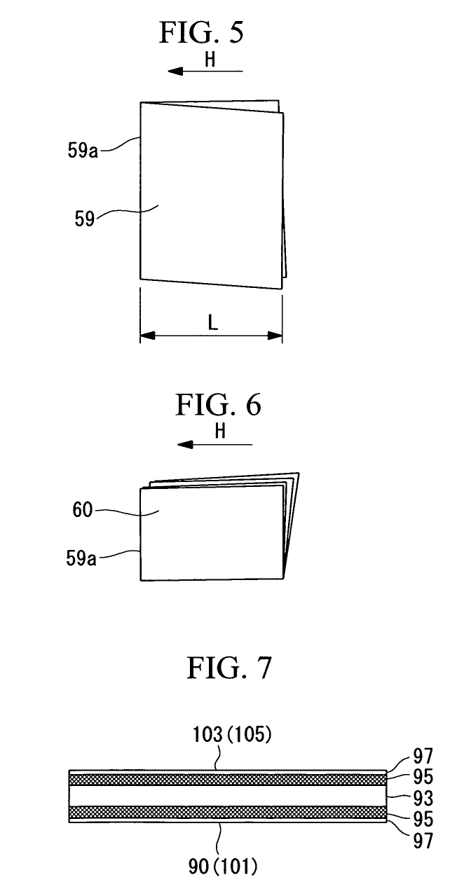

The conveyance belt section 47 receives a signature 59 (see FIG. 5) from the holding cylinder 45, and conveys the signature 59 to a post-process.

The conveyance belt section 47 includes a lower conveyance belt section 61 that guides and conveys a lower side of the signature 59 in a conveyance direction H, and an upper conveyance belt section 63 that guides and conveys an upper side of the signature 59.

The lower conveyance belt section 61 includes a plurality of endless belts that are separately disposed substantially in parallel in a width direction, for example, six lower conveyance belts 65, a lower drive guide roller 67, a lower adjustment guide roller 69, a plurality of lower guide rollers 71, and a plurality of, for example, two nip rollers (holding force increasing section, roller section) 73.

The number of the plurality of lower conveyance belts 65 are an even number. Each lower conveyance belt 65 is disposed at a position that is substantially laterally symmetrical with another lower conveyance belt 65 with respect to a folding position F where folding is carried out by a chopper blade 83, which is described below.

The lower conveyance belts 65 have a transfer pathway so that the belts 65 are driven to circle by the lower drive guide roller 67, the lower adjustment guide roller 69, the plurality of lower guide rollers 71, the plurality of nip rollers 73, and a chopper table 85 that is described below.

In the transfer pathway of the lower conveyance belt 65, a lower conveyance path section S is formed by the lower guide rollers 71 that are disposed near the holding cylinder 45, the two nip rollers 73, the chopper table 85, and the lower drive guide roller 67. The lower conveyance path section S guides and conveys the lower surface of the signature 59.

The lower drive guide roller 67 is installed at a downstream end position in the lower conveyance path section S to extend in the width direction, and driven to rotate by a driving section (not shown).

The lower guide rollers 71 that form the lower conveyance path section S are installed at positions where are upstream ends and lower than the lower drive guide roller 67 in the lower conveyance path section S to extend in the width direction.

The lower adjustment guide roller 69 is provided on the downward transfer pathway next to the lower drive guide roller 67. The lower adjustment guide roller 69 forms a roundabout transfer pathway together with the lower guide roller 71, which is disposed at the position lower than the lower adjustment guide roller 69, in a direction intersect with the transfer pathway, that is, in the conveyance direction H.

The lower adjustment guide roller 69 is installed movably in the conveyance direction H. The lower adjustment guide roller 69 adjusts a length of the roundabout transfer pathway by moving in the conveyance direction H to adjust the tension of the lower conveyance belt 65.

The upper conveyance belt section 63 includes a plurality of endless belts that are separately disposed substantially in parallel in the width direction, for example, six upper conveyance belts 75, an upper drive guide roller 77, an upper adjustment guide roller 79, and a plurality of upper guide rollers 81.

The number of the upper conveyance belts 75 is the same as that of the lower conveyance belts 65. The upper conveyance belts 75 are disposed above the lower conveyance belts 65 respectively. Accordingly, each upper conveyance belt 75 is disposed at a position that is substantially laterally symmetrical with another upper conveyance belt 75 with respect to the folding position F where folding is carried out by the chopper blade 83.

The upper conveyance belts 75 have a transfer pathway so that the belts 75 are driven to circle by the upper drive guide roller 77, the upper adjustment guide roller 79, and the upper guide rollers 81.

In the transfer pathway of the upper conveyance belt 75, an upper conveyance path section U is formed by the upper drive guide roller 77 and the upper guide rollers 81. The upper conveyance path section U is opposed to the lower conveyance path section S, and guides and conveys the upper surface of the signature 59.

The upper drive guide roller 77 is installed at a downstream end position in the upper conveyance path section U to extend in the width direction, and driven to rotate by a driving section (not shown).

The upper guide rollers 81 that form the upper conveyance path section U are installed at positions where are upstream ends in the upper conveyance path section U to extend in the width direction. The upper adjustment guide roller 79 is provided on the upward transfer pathway next to the upper drive guide roller 77.

The upper adjustment guide roller 79 forms a roundabout transfer pathway together with the upper guide roller 81, which is disposed above the upper adjustment guide roller 79, in a direction intersect with the transfer pathway, that is, in the conveyance direction H.

The upper adjustment guide roller 79 is installed to be movable in the conveyance direction H. The upper adjustment guide roller 79 adjusts a length of the roundabout transfer pathway by moving in the conveyance direction H to adjust the tension of the upper conveyance belt 75.

The chopper folding device 49 is provided at an intermediate position in the conveyance direction H of the conveyance belt section 47.

The chopper folding device 49 includes the chopper blade 83, the chopper table 85, a stopper 87, a pair of folding guides 89, a pair of folding rollers 91, and a signature guide (not shown).

The chopper blade 83 is a substantially rectangular plate that vertically reciprocates at a predetermined timing by swinging movement of a chopper arm (not shown).

The chopper table 85 is a substantially rectangular plate, and substantially horizontally disposed so that a height of an upper surface of the chopper table is substantially a same as a height of an upper end of the lower drive guide roller 67.

The chopper table 85 guides a lower surface of the lower conveyance belt 65. An upstream section of the chopper table 85 is formed to be a bent section (plate-like member) W that is slightly bent downward. The bent section W and the two nip rollers 73 form a convex section T that protrudes upward together with the holding cylinder 45 on the lower conveyance path section S. In the first embodiment, at a part where the lower conveyance path section S engages with the holding cylinder 45, a convex section that protrudes downward is formed.

That is, the convex section T is formed by the two nip rollers 73 to protrude upward than a line connecting an intersection K1 of the lower conveyance path section S with the holding cylinder 45 and an intersection K2 of the lower conveyance path section S with an upstream end on a horizontal section V of the chopper table 85.

The convex section T is bent at the two nip rollers 73 so that angles formed with the horizon toward the downstream side in the conveyance direction H gradually become small. Accordingly, the signature 59 passes through while being bent at the nip rollers 73.

A distance L2 from the intersection K2 to the nip point of the downstream nip rollers 73, a distance L3 between the nip points of the nip roller 73, and a distance L4 from the nip point of the upstream nip roller 73 to the intersection K1 are set to be shorter than a length L of the signature 59 to be conveyed in the conveyance direction H.

Accordingly, a distance L5 from the nip point of the upstream nip roller 73 to the nip point of the upstream upper guide roller 81 is shorter than the length L of the signature 59 to be conveyed in the conveyance direction H.

The upper guide roller 81 that forms the upper conveyance path section U may be moved downward or a nip roller may be provided in the upper conveyance path section U of the upper conveyance belt 75 to press downward. In this case, the convex section T is bent such that the angles formed with the horizon toward the downstream side in the conveyance direction H repeatedly become large and small. In this operation, the holding cylinder 45 also functions as the nip roller.

The convex section T may be formed to protrude downward by providing a nip roller at the upper conveyance belt 75 side.

At a substantially central part of the chopper table 85 in the width direction, an elongated opening is provided along the conveyance direction H. Along both edges of the opening, a pair of folding guides 89 is provided. The folding guides 89 have a bar shape, and whose cross section is substantially a sector form.

The pair of the folding guides 89 is attached with a space between the circumferential surfaces and to be opposed to each other. The space is formed to be closer toward the lower ends. The chopper blade 83 passes between the pair of folding guides 89, that is, the folding position F. The chopper blade 83 forms a chopper signature 60 (see FIG. 6) by folding the signature 59 in two.

A stopper 87 is provided at a position on the downstream side of the chopper blade 83 in the conveyance direction H. The stopper 87 is vertically reciprocated by a drive mechanism (not shown).

A lower surface of the stopper 87 is brought into contact with an upper surface of the guide plate 67 when the stopper 87 moves downward. Then, a tip 59a of the signature 59 comes in contact with the stopper 87, and the signature 59 is stopped.

A pair of folding rollers 91 is installed below the folding guides 89 such that axis lines of the folding rollers are along the conveyance direction H, the folding rollers are adjacent to each other, and a space between the folding rollers is adjustable.

The pair of the folding rollers 91 is driven to rotate such that the opposed parts move downward respectively.

The right-angle folding impeller 51 is installed below the folding rollers 91 such that an axis line is along the conveyance direction H. The right-angle folding impeller 51 receives the chopper signature 60 that is chopper-folded (folded at right angle) by the chopper blade 83 and conveys the signature 60 to the discharge conveyer 55.

The parallel folding impeller 53 is installed below a downstream end of the lower conveyance belt 65 such that an axis line is orthogonal to the conveyance direction H.

The parallel folding impeller 53 receives the signature 59 that is not chopper-folded by the chopper blade 83 and conveyed by the lower conveyance belt 65, and conveys the signature 59 to the discharge conveyer 57.

For the lower conveyance belt 65 (upper conveyance belt 75), for example, the POLYBELT® Type KCS-350 produced by Nitta Corporation is used.

FIG. 4 is a cross sectional view illustrating the lower conveyance belt 65 (upper conveyance belt 75). The lower conveyance belt 65 (upper conveyance belt 75) has a width B of, for example, 15 mm, and a thickness D of, for example, 1.1 mm.

The lower conveyance belt 65 includes a tension member 93 formed of a drawn polyamide film, polyamide fabrics 95 that are bonded to both surfaces of the tension member 93, and a nitrile rubber (NBR) 97 that is coated on one of the polyamide fabrics 95.

The nitrile rubber 97 side of the lower conveyance belt 65 (upper conveyance belt 75) is used as a drive surface (inner circumferential surface) 99 (101), and the polyamide fabric 95 side is used as a lower conveyance surface 103 or an upper conveyance surface 105 that is an outer circumference surface.

A coefficient of static friction of the lower conveyance surface 103 or the upper conveyance surface 105 to a surface of an iron material is set to 0.2 or more and less than 0.3. The value is smaller than that of conventional conveyance belts.

A coefficient of static friction of the inner circumferential surface 99 (101) to the surface of the iron material is set to, for example, 0.3 or more and less than 0.4. With the structure, the drive force from the lower drive guide roller 67 or the upper drive guide roller 77 is sufficiently transmitted to the lower conveyance belt 65 and the upper conveyance belt 75. Accordingly, the lower conveyance belt 65 and the upper conveyance belt 75 are driven with the sufficient drive force.

The coefficient of static friction of the inner circumferential surface 99 (101) to the surface of the iron material may be 0.4 or more. However, if the value is too large, for example, friction resistance to the chopper table 85 is increased. Accordingly, preferably, the coefficient of static friction is set to a value less than 0.5.

The structure of the lower conveyance belt 65 (upper conveyance belt 75) is an example, and various structures that have coefficients of static friction of the lower conveyance surface 103 or the upper conveyance surface 105 to the surface of the iron material of 0.2 or more and less than 0.3 may be employed.

Now, operation of the web press 1 according to the first embodiment is described.

The web 19 fed by the paper feed device 3 is conveyed to the in-feed device 5, and the tension is adjusted by the in-feed device 5. Then, the web 19 is fed to the printing unit 23 of the printing section 7.

In each printing unit 23, dampening water and ink is supplied, and an image formed on a plate attached on the periphery of the plate cylinder 25 is transferred to the blanket cylinder 27. The image is transferred and printed on both surfaces of the web 19 that passes through between the blanket cylinders 27.

The web 19 passes through the four printing units 23, and images of cyan, yellow, magenta, and black are printed. Thus, color printing is performed.

The web 19 that is passed through each printing unit 23 and color-printed is heated by the drying device 9, and the ink is dried.

Then, the web 19 is passes through each cooling drum 29 of the cooling device 11 such that the web 19 comes in contact with the periphery of each cooling drum 29, and the web 19 is cooled by each cooling drum 29. The tension of the web 19 is adjusted by the web pass section 13, and the web 19 is vertically folded by the trigon 31, and fed to the folding machine 15.

In the folding machine 15, the web 19 is fed to the downstream side by the first nipping roller section 35 and the second nipping roller section 39, and introduced into a space between the folding cylinder 43 and the holding cylinder 45 that are rotating in directions opposed to each other. At this time, if necessary, a perforated line that is to be a fold line is formed on the web 19 by the lateral sewing machine 37.

The folding cylinder 43 pushes the needles of the needle device on the tip of the web 19, and rotates while holding the web 19.

The web 19 conveyed by the rotation of the folding cylinder 43 is tucked onto the holding members of the holding cylinder 45 at a predetermined position by the folding blades that protrude from the folding cylinder 43 and held by the holding members. At the timing, the needle device of the folding cylinder 43 retracts, and the web 19 is fed to the holding cylinder 45.

When the web 19 held and conveyed by the holding cylinder 45 is conveyed at a predetermined position, the upstream side is cut in the lateral direction, and the signature 59 (see FIG. 5) of the length L in the conveyance direction H is formed.

At a timing the signature 59 is at an upper point of the conveyance belt 45, the holding members are released, and the signature 59 is fed to the lower conveyance belt 65.

By repeating the above operation, the signatures 59 are sequentially conveyed at certain spaces on the lower conveyance belt 65.

When the signature 59 conveyed on the lower conveyance belt 65 arrives at the position where the upper conveyance belt 75 catches the signature 59, the signature 59 is held and conveyed by the lower conveyance belt 65 and the upper conveyance belt 75.

At this time, the signature 59 is bent to protrude upward at the nip roller 73. Accordingly, peripheral velocities of the inside and outside of the signature 59 passing through the nip roller 73 differ from each other. That is, the peripheral velocity of the surface of the signature 59 of the upper conveyance surface 105 side is faster than that of the surface of the signature of the lower conveyance surface 103 side.

Meanwhile, the lower conveyance surface 103 and the upper conveyance surface 105 move at a substantially same speed. Accordingly, a speed difference occurs between the upper conveyance surface 105 and the surface of the signature 59. Then, the upper conveyance surface 105 controls the movement of the signature 59 to even the speed difference. Accordingly, a stress to press the signature 59 from the upper conveyance surface 105 is generated.

As described above, since the upper conveyance surface 105 presses the signature 59, the holding force that the lower conveyance surface 103 and the upper conveyance surface 105 hold the signature 59 is increased.

If the holding force acting on the signature 59 is increased, it is possible to increase the conveyance force for conveying the signature 59 on the lower conveyance surface 103 and the upper conveyance surface 105. Accordingly, the reduction of the conveyance force with the reduction of the coefficient of static friction of the lower conveyance surface 103 and the upper conveyance surface 105 can be compensated, and the conveyance force can be held and ensured at a level higher than a necessary level.

Accordingly, the attitude of the signature 59 can be maintained without displacement, and the signature 59 can be conveyed in good condition.

During the conveyance, a slip may occur between the lower conveyance surface 103 and the upper conveyance surface 105 and the surface of the signature 59. However, since the coefficients of static friction of the lower conveyance surface 103 and the upper conveyance surface 105 are set to a small value, the signature 59 can be smoothly slipped, and the signature 59 is prevented from being damaged.

As described above, with the simple structure to provide the nip rollers 73, the holding force can be increased.

The increase of the holding force is also performed between the holding cylinder 45 and the lower conveyance belt 65 and in the bent section W that is on the upstream side of the chopper table 85. Further, if the upstream side upper guide roller 81 is pushed toward the lower conveyance belt 65, the increase of the holding force is also performed at the place.

At the position where the conveyed signature 59 arrives at the chopper folding device 49 and passes the intersection K2, the conveyance force for conveying the signature 59 by the lower conveyance belt 65 and the upper conveyance belt 75, that is, the holding force for holding the signature 59 against the external force, is reduced since the coefficient of static friction of the lower conveyance surface 103 and the upper conveyance surface 105 for holding and conveying the signature 59 is set to 0.2 or more and less than 0.3, which is smaller than conventional values.

Accordingly, the signature 59 is conveyed while the area which is lightly held by the lower conveyance belt 65 and the upper conveyance belt 75 expands from the tip 59a of the signature, as the ratio of the area is gradually increased. However, the upstream side of the signature 59 is caught by the bent section W that is on the upstream side of the chopper table 85 and the holding force is increased. Accordingly, the signature 59 is conveyed in good condition while the attitude of the signature 59 is maintained without displacement.

Further, the distances L2, L3, and L4 are set to values smaller than the length L of the signature 59 in the conveyance direction H respectively. Then, the signature 59 that passes through the convex section T is surely caught by the bent part of the chopper table 87, the holding cylinder 45, and the nip roller 71, no matter where the signature 59 passes through. Accordingly, the signature 59 is always conveyed in the state that the holding force is increased.

Further, since the bent section W of the chopper table 87 is provided at the downstream part of the convex section T, the signature 59 is passed through the convex section T, and conveyed to a place near the stopper 87 with the sufficient conveyance force.

When the tip 59a of the signature 59 arrives at the point of the stopper 87, the stopper moves downward at a timing and stops the tip 59a of the signature 59.

The distance L1 from the stopper 87 to the intersection K is set to a value longer than the length L of the signature 59. Therefore, at the point where the tip 59a of the signature 59 comes in contact with the stopper 87, the entirety of the signature 59 is lightly held by the lower conveyance belt 65 and the upper conveyance belt 75.

Accordingly, when the signature 59 comes in contact with the stopper 87, under the reaction force due to the contact, the signature 59 can readily move, and the impact force that is generated when the signature 59 comes in contact with the stopper 87 can be reduced. As described above, since it is possible to reduce the impact force acting on the signature 59, a misshapen fold or a rip of the signature 59 can be prevented from being formed due to the strong force acting on the tip 59a of the signature 59, and the position of the tip 59a of the signature 59 can be readily aligned.

At approximately the same time, the chopper blade 83 is swung to move the folding position F downward and to come in contact with the signature 59, and further, to pushe the signature 59 downward.

By the operation, the substantially central part of the signature 59 in the width direction is moved downward, and both ends of the signature 59 are moved toward a central part respectively.

Since the coefficient of static friction of the lower conveyance surface 103 and the upper conveyance surface 105 is small, the both ends of the signature 59 can be smoothly moved toward the central part as the folding proceeds. Further, even if the holding forces of the signature 59 at the lower conveyance belt 65 and the upper conveyance belt 75 in the width direction are imbalanced, variations of the movement amounts of the both ends can be reduced.

Further, the chopper table 85 is formed to have a horizontal section V that is substantially horizontal on the downstream side section with respect to the intersection K2. When the tip of the signature comes in contact with the stopper, the signature is held at the horizontal section V. Accordingly, the signature 59 is folded by the chopper blade 83 in the substantially horizontal state.

With the above-described structures, the chopper blade 83 can accurately fold the signature 59 in two, and inaccurate folding can be reduced. Further, adjustments corresponding to change in paper quality of the signature, thickness of the paper, the number of pages, and the like can be substantially eliminated.

As described above, the signature 59 is folded in two along the conveyance direction H to be the chopper signature 60 (see FIG. 6).

The chopper signature 60 is pressed and folded by the pair of folding rollers 91, and conveyed downward.

The chopper signature 60 passed through the folding rollers 91 is dropped between adjacent blades of the right-angle folding impeller 51 that rotates at a timing. Then, the chopper signature 60 is conveyed downward by the rotation of the right-angle folding impeller unit 51, and dropped on the discharge conveyer 55.

Since the chopper signatures 60 are sequentially dropped on the discharge conveyer 55 and conveyed, the chopper signatures 60 are conveyed in an imbricated state.

Now, advantages of the present invention will be described using an example and a comparative example.

### EXAMPLE

A printing was performed using the POLYBELT® Type KCS-350 (width: 15 mm, thickness: 1.1 mm) produced by Nitta Corporation having a configuration shown in FIG. 4 for the lower conveyance belt 65 and the upper conveyance belt 75 in the printing device LITHOPIA MAX AY1-700 produced by Mitsubishi Heavy Industries, Ltd., and 16 pages of A-4 sized chopper signatures 60 were obtained.

A coefficient of static friction of the lower conveyance surface 103 and the upper conveyance surface 105 to a surface formed of an iron material was set to 0.2 or more and less than 0.3.

For the web 19, two types of coated paper of basis weight of 49 g/m² and 73 g/m² were used. A printing speed, that is, the number of rotations of the plate 25 was varied to 600, 650, 700, 750, and 800 rpm. Under the conditions, signatures 59 were examined for any rip formed due to contact with the stopper 87 (such a rip hereinafter referred to as a “contact rip”).

### COMPARATIVE EXAMPLE

A printing was performed using the POLYBELT® Type SG-500 (width: 15 mm, thickness: 1.1 mm) produced by Nitta Corporation having a configuration shown in FIG. 7 for the lower conveyance belt 65 and the upper conveyance belt 75 similarly to conventional examples, and under the same conditions as the above example except for the type of the POLYBELT®. Under the conditions, signatures 59 was examined for any contact rip.

As shown in FIG. 7, the POLYBELT® Type SG-500 had a structure that on surfaces of the both polyamide fabrics 95, the nitrile rubbers 97 were coated. A coefficient of static friction of the lower conveyance surface 103 and the upper conveyance surface 105 to the surface of the iron material was set to 0.3 or more and less than 0.4.

The coefficient of static friction to the surface of the iron material was measured, specifically, as described below.

On a slide table movable in a horizontal direction, a plate-like material to be measured formed of an iron material (for example, stainless steel) was fixed and attached. Then, a measurement jig, which was formed by belt sections cut into a predetermined size and attached on a flat surface, was placed on the slide table such that the belt sections are placed over the material to be measured. A plummet of a predetermined weight was placed on the measurement jig. Then, a load cell that can measure loads in the horizontal direction was connected to the measurement jig.

In this state, the slide table was moved in the horizontal direction, and loads (resistance values) in the horizontal direction applied on the measurement jig were measured by the load cell. Coefficients of friction were calculated based on ratios of the measured resistance values and loads applied in a vertical direction. A maximum value in the calculated friction coefficients is the coefficient of static friction.

A result of the measurement using the coated paper of basis weight of 49 g/m² is shown in Table 1.

TABLE 1

| Coefficient of | | | | | |
|---|---|---|---|---|---|
| friction of | Number of rotations | | | | |
| conveyance surface | up to | up to | up to | up to | up to |
| of belt | 600 rpm | 650 rpm | 700 rpm | 750 rpm | 800 rpm |
| 0.2 (inclusive) to | Good | Good | Good | Good | Poor |
| 0.3 (exclusive) | | | | | |
| (KCS-350) | | | | | |
| 0.3 (inclusive) to | Good | Poor | Poor | Poor | Poor |
| 0.4 (exclusive) | | | | | |
| (SG-500) | | | | | |

Good: No contact rip was made.
Poor: A contact rip was made.

A result of the measurement using the coated paper of basis weight of 73 g/m² is shown in Table 2.

TABLE 2

| Coefficient of | | | | | |
|---|---|---|---|---|---|
| friction of | Number of rotations | | | | |
| conveyance surface | up to | up to | up to | up to | up to |
| of belt | 600 rpm | 650 rpm | 700 rpm | 750 rpm | 800 rpm |
| 0.2 (inclusive) to | Good | Good | Good | Good | Good |
| 0.3 (exclusive) | | | | | |
| (KCS-350) | | | | | |
| 0.3 (inclusive) to | Good | Good | Good | Poor | Poor |
| 0.4 (exclusive) | | | | | |
| (SG-500) | | | | | |

Good: No contact rip was made.
Poor: A contact rip was made.

As understood from the tables 1 and 2, it was confirmed that in the example performed using the lower coefficient of static friction, a contact rip was not observed until the number of rotations became high printing speeds as compared with the comparative example. That is, the impact force in the collision against the stopper 87 was reduced.

### Second Embodiment

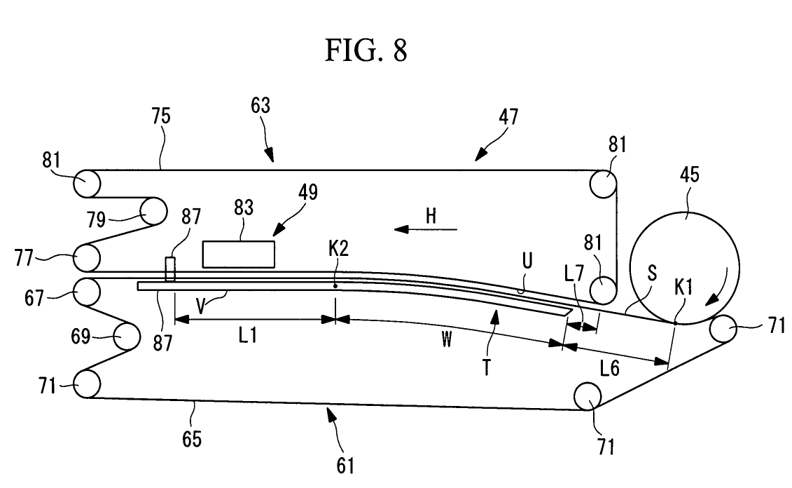

Now, the web press 1 according to a second embodiment is described with reference to FIG. 8.

The second embodiment differs from the first embodiment only in structures of the holding force increasing sections. Accordingly, in the second embodiment, the different point is mainly described, and the descriptions of the same parts as the above-described first embodiment are omitted.

To the same members as those in the first embodiment, the same reference numbers are applied.

In the second embodiment, the bent section (plate-like member) W in the upstream side of the chopper table 85 is provided in the upstream side, for example, the bent section W is extended to a point near the upper guide roller 81 of the upstream side.

The bent section W may have a predetermined curvature, or, gradually varying curvatures.

Unlike the first embodiment, the nip roller 71 is not used, but the convex section T that protrudes upward is formed on the lower conveyance path section S by the bent section W and the holding cylinder 45. In the second embodiment, a part which engages the holding cylinder 45 of the lower conveyance path section S is formed as a convex section that protrudes downward.

That is, the convex part T is formed by the bent section W to protrude upward than a line connecting the intersection K1 of the lower conveyance path section S with the holding cylinder 45 and the intersection K2 of the lower conveyance path section S with the upstream end of the horizontal section V of the chopper table 85.

The convex section T may be formed to protrude downward, for example, by bending the bent section W to protrude downward.

A distance L6 from the upstream end of the bent section W to the intersection K1 is set to be shorter than the length L of the signature 59 to be conveyed in the conveyance direction H. Accordingly, a distance L7 from the upstream end of the bent section W to the nip point of the upstream upper guide roller 81 is shorter than the length L of the signature 59 to be conveyed in the conveyance direction H.

A printing operation of the web press 1 according to the second embodiment is similar to that in the first embodiment. Accordingly, overlapping descriptions are omitted, and a conveyance operation of the signature 59 by the lower conveyance belt 65 and the upper conveyance belt 75 is described.

When the signature 59 conveyed on the lower conveyance belt 65 arrives at the position where the upper conveyance belt 75 catches the signature 59, the signature 59 is held and conveyed by the lower conveyance belt 65 and the upper conveyance belt 75.

In this state, if the signature 59 proceeds to the part of the bent section W, the signature 59 is introduced to the bent section W. Then, the signature 59 is bent to protrude upward along a curvature of the bent section W.

If the signature 59 is conveyed in the bent state, peripheral velocities of the inside and outside of the signature 59 differ from each other. That is, the peripheral velocity of the surface of the signature 59 of the upper conveyance surface 105 side is faster than that of the surface of the signature 59 of the lower conveyance surface 103 side.

Meanwhile, the lower conveyance surface 103 and the upper conveyance surface 105 move at a substantially same speed. Accordingly, a speed difference occurs between the upper conveyance surface 105 and the surface of the signature 59. Then, the upper conveyance surface 105 controls the movement of the signature 59 to even the speed difference. Accordingly, a stress is generated to press the signature 59 from the upper conveyance surface 105.

As described above, since the upper conveyance surface 105 presses the signature 59, the holding force for holding the signature 59 by the lower conveyance surface 103 and the upper conveyance surface 105 is increased.

If the holding force acting on the signature 59 is increased, it is possible to increase the conveyance force of the lower conveyance surface 103 and the upper conveyance surface 105 to convey the signature 59. Accordingly, the reduction of the conveyance force with the reduction of the coefficient of static friction of the lower conveyance surface 103 and the upper conveyance surface 105 can be compensated, and the conveyance force can be maintained and ensured at a level higher than a necessary level.

Accordingly, the attitude of the signature 59 can be maintained, and the signature 59 can be conveyed in good condition without displacement.

During the conveyance, a slip may occur between the lower conveyance surface 103 and the upper conveyance surface 105 and the surface of the signature 59. However, since the coefficient of static friction of the lower conveyance surface 103 and the upper conveyance surface 105 is set to a small value, the signature 59 can be smoothly slipped, and the signature 59 is prevented from being damaged.

As described above, with the simple structure to extend the bent section W of the chopper table 85 to the upstream side, the holding force can be increased.

Further, since the bent section W covers a substantially overall length of the upstream part of the upper conveyance path section U, the area to increase the holding force can be formed long in the conveyance direction.

In the second embodiment, the convex section T is formed by extending the bent section W of the chopper table 85 to the upstream side, however, it is not limited to the above.

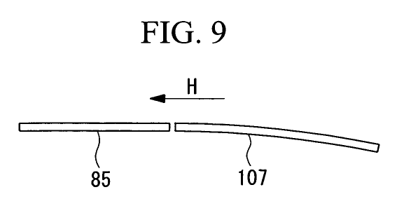

For example, as shown in FIG. 9, a bent plate (plate-like member) 107 that independently bent may be provided at the upstream side of the chopper table 85.

Further, the bent plate 107 may be divided into a plurality of pieces in the conveyance direction H, and installed with spaces. In this case, to ensure accurate conveyance of the signature 59, it is preferable to set the spaces shorter than the length L of the signature 59 in the conveyance direction H.

It is to be understood that the present invention is not limited to the above-described embodiments, but can be appropriately modified without departing from the scope of the present invention.

What is claimed is:

1. A folding machine comprising:
an endless lower conveyance belt that forms a lower conveyance path section for guiding and conveying a lower surface of a signature by a lower conveyance surface of an outer circumference side;
an endless upper conveyance belt that forms an upper conveyance path section for guiding and conveying an upper surface of the signature by an upper conveyance surface of an outer circumference side;
a chopper table that is installed below the lower conveyance path section, and guides an inner circumference surface of an inner circumference side of the lower conveyance belt;
a stopper that is installed on the chopper table and aligns a downstream end position of the signature; and
a chopper blade for folding the signature in two along a signature conveyance direction,
wherein a coefficient of static friction of the lower conveyance surface and the upper conveyance surface to a surface formed of an iron material is 0.2 or more and less than 0.3, and
a holding force increasing section for increasing holding force to the signature between the lower conveyance surface and the upper conveyance surface is provided at a part more upstream side than the stopper in the lower conveyance path section and the upper conveyance path section by at least a length of the signature.

2. The folding machine according to claim 1, wherein the holding force increasing section is a convex section formed by protruding the lower conveyance path section and the upper conveyance path section upward or downward along the conveyance direction.

3. The folding machine according to claim 2, wherein the convex section is formed according to a curvature of a plate-like member for guiding the lower conveyance belt or the upper conveyance belt.

4. The folding machine according to claim 2, wherein the convex section is formed by a plurality of roller members for guiding the lower conveyance belt or the upper conveyance belt.

5. The folding machine according to claim 4, wherein spaces between the roller members in the conveyance direction are shorter than the length of the signature.

6. The folding machine according to claim 1, wherein the chopper table includes a horizontal section that is equal to or longer than at least the length of the signature and substantially horizontal at a part more upstream side than the stopper.

7. The folding machine according to claim 1, wherein the coefficient of static friction of the inner circumference surfaces of the inner circumference side of the lower conveyance belt and the upper conveyance belt to the surface formed of the iron material is 0.3 or more and less than 0.5.

8. A printing machine that includes the folding machine according to claim 1.
